(19) United States
(12) Patent Application Publication
(10) Pub. No.: US 2003/0198573 A1
(43) Pub. Date: Oct. 23, 2003

(54) Sensor arrays for detecting analytes in fluids

(75) Inventors: Behrouz B. Forood, Encintas, CA (US); Michal Lebl, San Diego, CA (US)

Correspondence Address: Robin M. Silva, Dorsey & Whitney LLP, Intellectual Property Department, Four Embarcadero Center, Suite 300, San Francisco, CA, 94111-4187, US

(73) Assignee: Illumina, Inc.

(21) Appl. No.: 10/352,779

(22) Filed: Jan. 27, 2003

Related U.S. Application Data
(60) Provisional application No. 60/352,102, filed on Jan. 25, 2002.

(51) Int. Cl. G01J 3/30; B32B 27/12; G01N 21/64

(52) U.S. Cl. 422/82.08; 356/317

(57) ABSTRACT

In accordance with the objects outlined above, the present invention provides sensor arrays for the detection of target analytes. The sensor arrays comprising a substrate comprising a surface comprising discrete sites, each discrete site comprising a solvatochromic dye and at least one micro-environment moiety (MEM), both of which are preferably covalent attached to the discrete site. In some aspects, the discrete sites comprise microspheres to which the dyes and MEMs are attached, again, preferably covalently. The dye(s) and MEM(s) at each site can be independently attached, or they can be co-attached using a linker.

This application is a continuation-in-part application of U.S.S.No. 60/352,102, filed Jan. 25, 2002.

### FIELD OF THE INVENTION

### BACKGROUND OF THE INVENTION

There is considerable interest in the development of rapid, automated, reproducible, inexpensive sensors for a variety of target analytes, including nucleic acids, proteins, and a variety of chemical analytes. In particular, sensors that act as analogs of the mammalian olfactory system are particularly desirable for a variety of reasons. The olfactory system is thought to rely on probabilistic repertoires of many different receptors to recognize a single odorant, creating a “signature” or “fingerprint” of different receptor responses. See U.S. Pat. No. 6,010,616 and references cited therein.

In general, these systems have fallen into two categories: electronic (“the electronic or e-nose”) and the optical (“optical or o-nose”). Electronic sensors generally rely on arrays of different polymers that exhibit characteristic differences in conductivity upon response to an analyte. Similarly, optical sensors rely on different optical responses, in some cases using solvatochromic dyes, to identify analytes. In both cases characteristic “fingerprints” of different sensor elements serve to identify the analytes.

Various detection platforms are used to detect a multitude of different analytes. Prior attempts to produce a broadly responsive sensor array have exploited heated metal oxide thin film resistors, polymer sorption layers on the surfaces of acoustic wave resonators, arrays of electrochemical detectors, or conductive polymers. Arrays of metal oxide thin film resistors, typically based on SnO2 films that have been coated with various catalysts, yield distinct, diagnostic responses for several vapors. However, due to the lack of understanding of catalyst function, SnO2 arrays do not allow deliberate chemical control of the response of elements in the arrays nor reproducibility of response from array to array. Generally, previous sensors were prepared by non-covalent attachment of sensors entities with a support. The non-covalent attachment methods suffered from a lack of desired stability (toward moisture and polar solvents), limited sensor variety, and reproducibility problems in sensor preparation.

In addition, one drawback with optical systems is the finite availability of different resolvable dyes. Thus it has been difficult to create large sensor arrays of different elements that allow for good selectivity and sensitivity.

Accordingly, a need exists for a robust and stable optical sensor array.

### SUMMARY OF THE INVENTION

In accordance with the objects outlined above, the present invention provides sensor arrays for the detection of target analytes. The sensor arrays comprising a substrate comprising a surface comprising discrete sites, each discrete site comprising a solvatochromic dye and at least one micro-environment moiety (MEM), both of which are preferably covalent attached to the discrete site. In some aspects, the discrete sites comprise microspheres to which the dyes and MEMs are attached, again, preferably covalently. The dye(s) and MEM(s) at each site can be independently attached, or they can be co-attached using a linker.

In an additional aspect, the invention provides methods of detecting a target analyte in a sample comprising contacting the sample with a sensor array as outlined herein and measuring the optical response of a plurality of the discrete sites.

In a further aspect, the invention provides arrays comprising a population of sensors comprising:

a) a first subpopulation comprising

i). a first solvatochromic dye covalently attached to a first site on a substrate;

ii). a first MEM covalently attached to said first site on said substrate; and

b) a second subpopulation comprising:

i) said first solvatochromic dye covalently attached to a second site on said substrate;

ii) a second MEM covalently attached to said second site on said substrate.

In an additional aspect, the invention provides arrays comprising a population of sensors comprising:

a) a first subpopulation comprising:

i). a first solvatochromic dye covalently attached to a first site on a substrate;

ii). a first MEM covalently attached to said first site on said substrate; and

b) a second subpopulation comprising:

i) a second solvatochromic dye covalently attached to a second site on said substrate;

ii) said first MEM covalently attached to said second site on said substrate.

### BRIEF DESCRIPTION OF THE DRAWINGS

FIGS. 1A-1F schematically depict a number of different embodiments of the invention. FIG. 1A depicts a system wherein each dye molecule and each MEM molecule is separately attached to the surface. FIG. 1B depicts a similar system, except a plurality (in this case, two) of different MEMs are used. FIG. 1C uses a different configuration, wherein a linker comprising a plurality of MEMs is used and the dye is attached separately. As noted below, the ratios of each component on the system may be varied as well. FIGS. 1D-G all depict the use of oligomers for attaching dyes and MEMs in different configurations. In these figures n is an integer of at least 1. Both FIGS. 1F and 1G depict configurations amenable to a combinatorial synthetic approach, particularly in the case of microspheres that can be easily manipulated during synthetic steps.

FIG. 2 is a further depiction of sensor formats, with R being either an attachment linker for the attachment of MEMs or the MEMs themselves, and NR is one embodiment, Nile Red. However, as will be appreciated by those in the art, Nile Red can be substituted by any solvatochromic dye. In addition, FIG. 2A depicts a schematic of sensor mechanism.

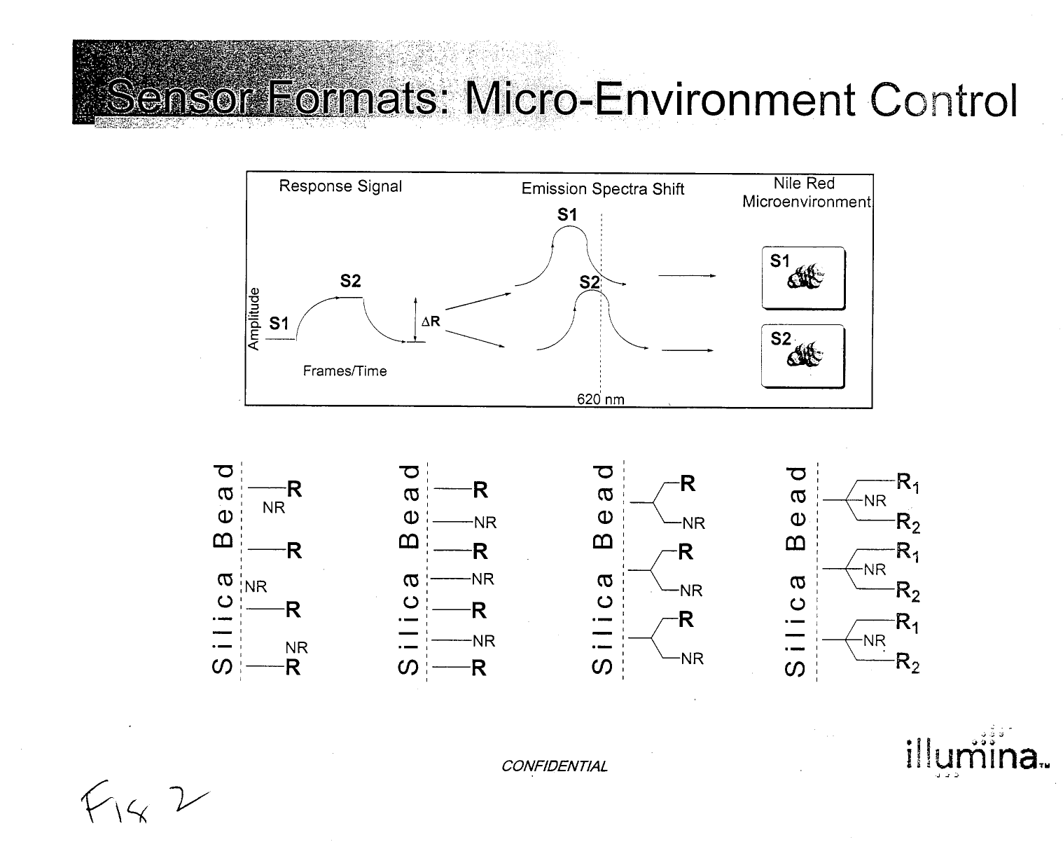

FIG. 3 depicts a schematic of surface modification using silanes, and some exemplary MEMs. NR is one embodiment, Nile Red. However, as will be appreciated by those in the art, Nile Red can be substituted by any solvatochromic dye.

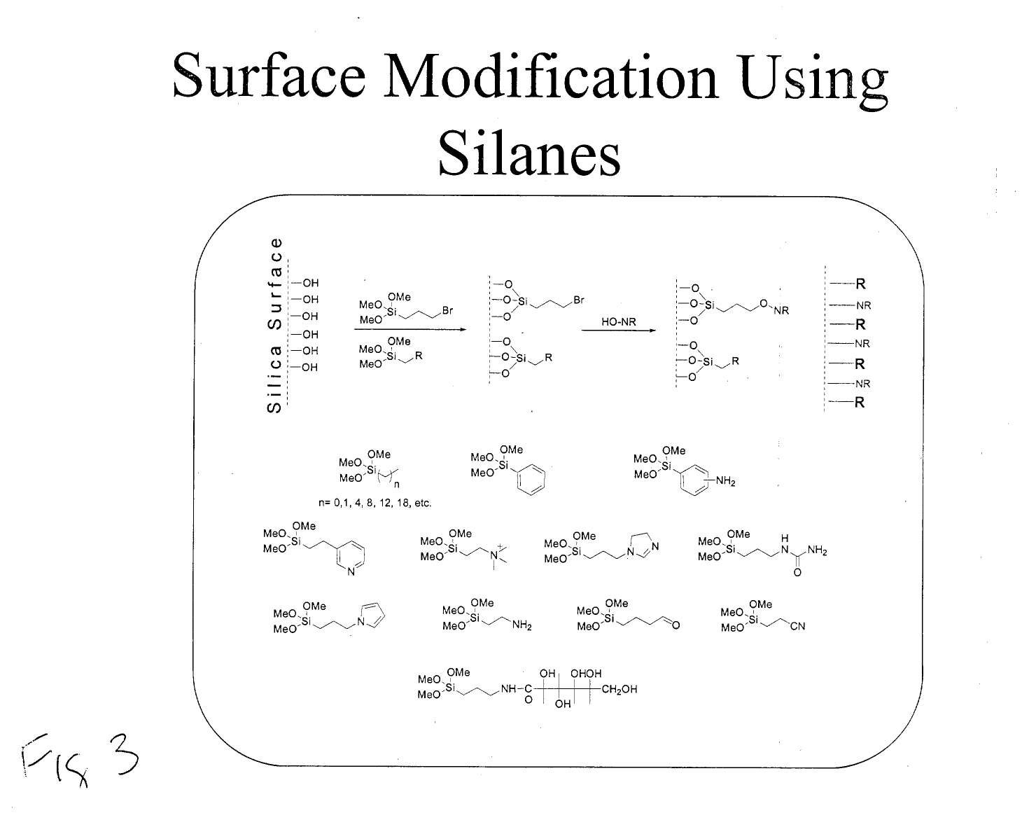

FIG. 4 depicts some exemplary solvatochromic dyes. As will be appreciated by those in the art, functional groups present on these molecules may be used to add them to the surfaces as outlined herein, or additional functional groups may be added using well-known techniques.

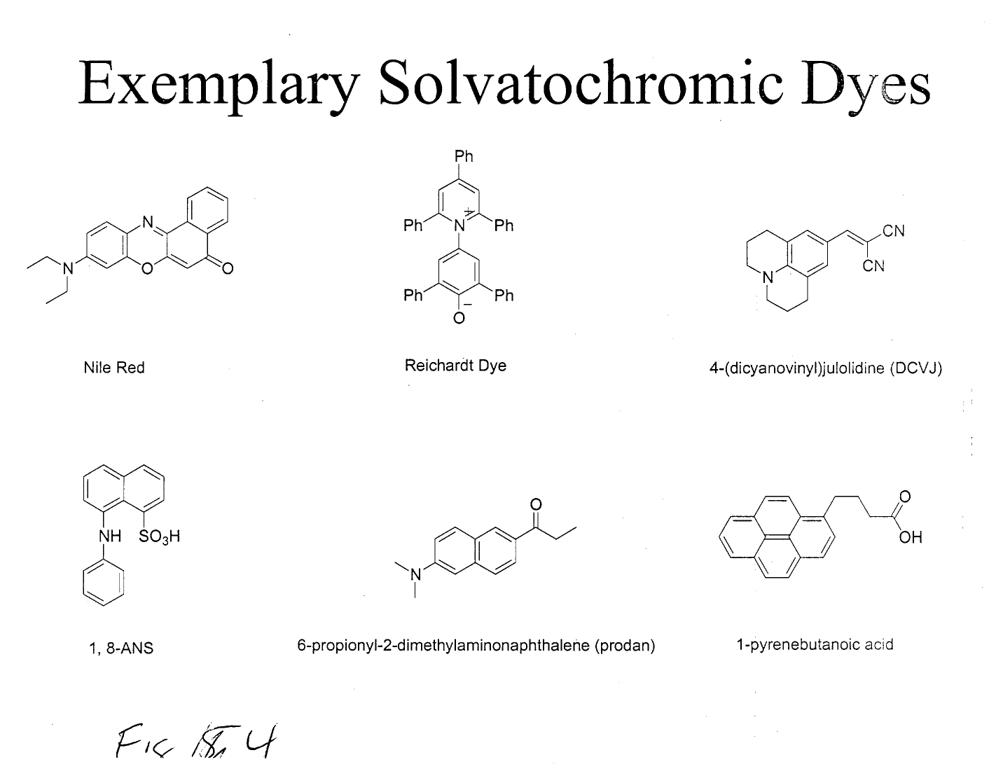

FIG. 5 depicts two approaches for attachment of a functional group (FG) for attachment.

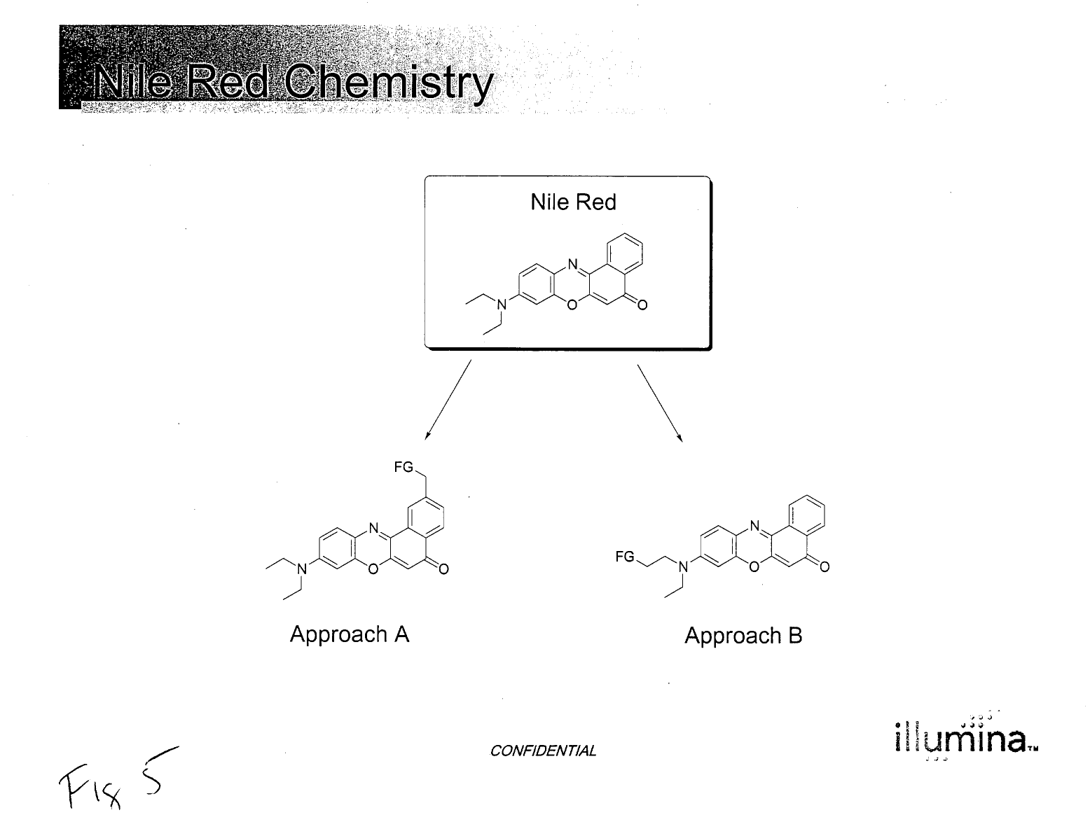

FIG. 6 depicts the attachment of Nile Red to beads (or other surfaces) using silane chemistry and an ether bond formation.

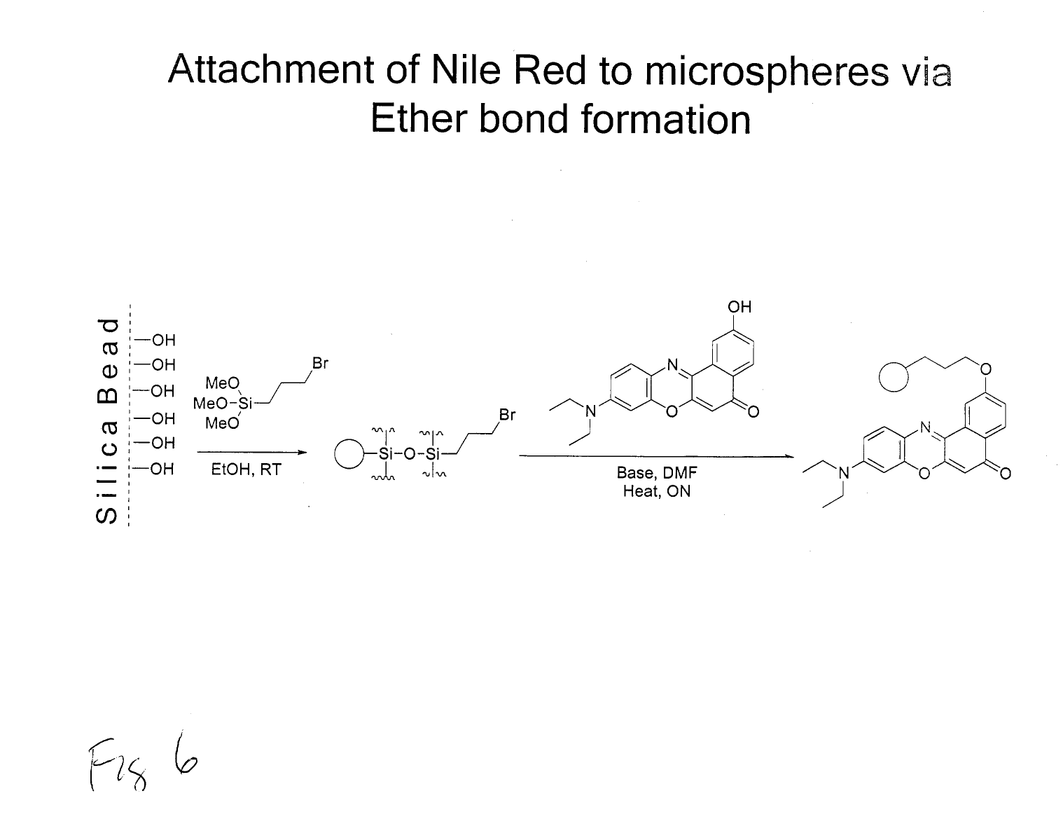

FIG. 7 depicts the stability of the ether bond of FIG. 6.

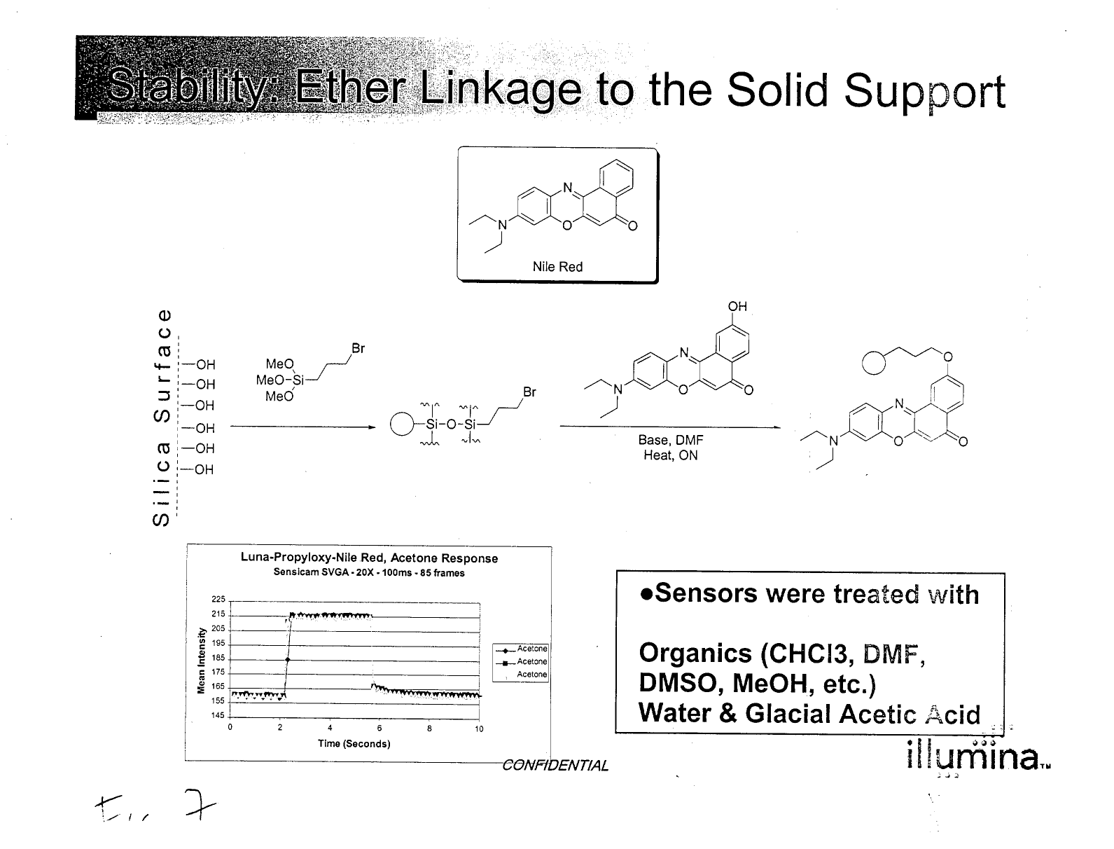

FIG. 8 depicts alternative chemistry for the attachment of Nile Red.

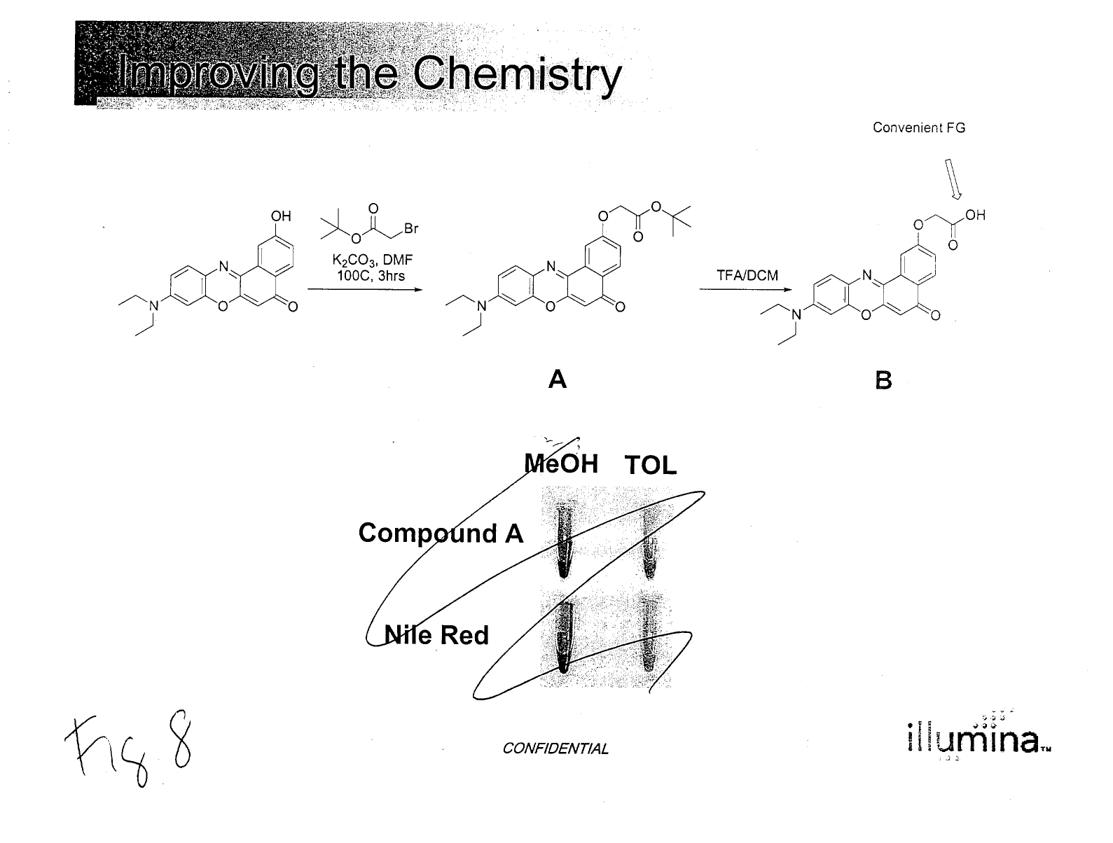

FIG. 9 depicts the sensitivity of different sensors comprising different MEMs.

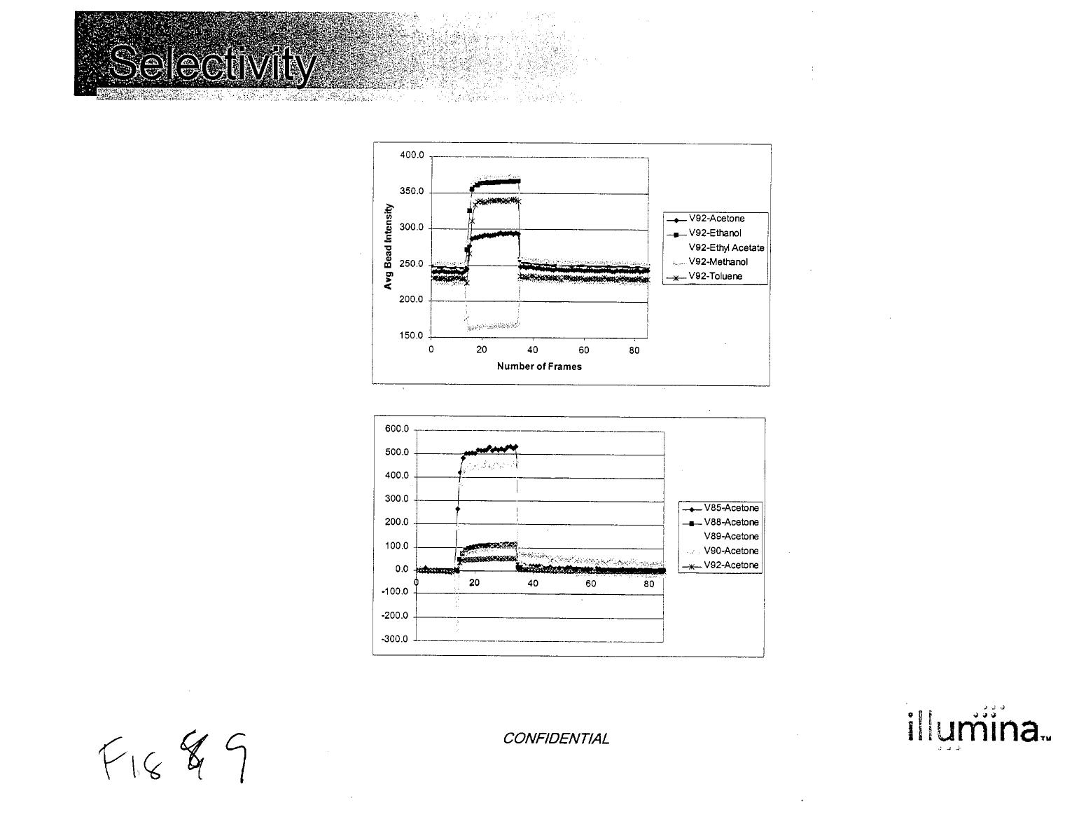

FIG. 10 depicts surface modifications using an oligomeric linker, in this case a branched amino acid system. NR is one embodiment, Nile Red. However, as will be appreciated by those in the art, Nile Red can be substituted by any solvatochromic dye.

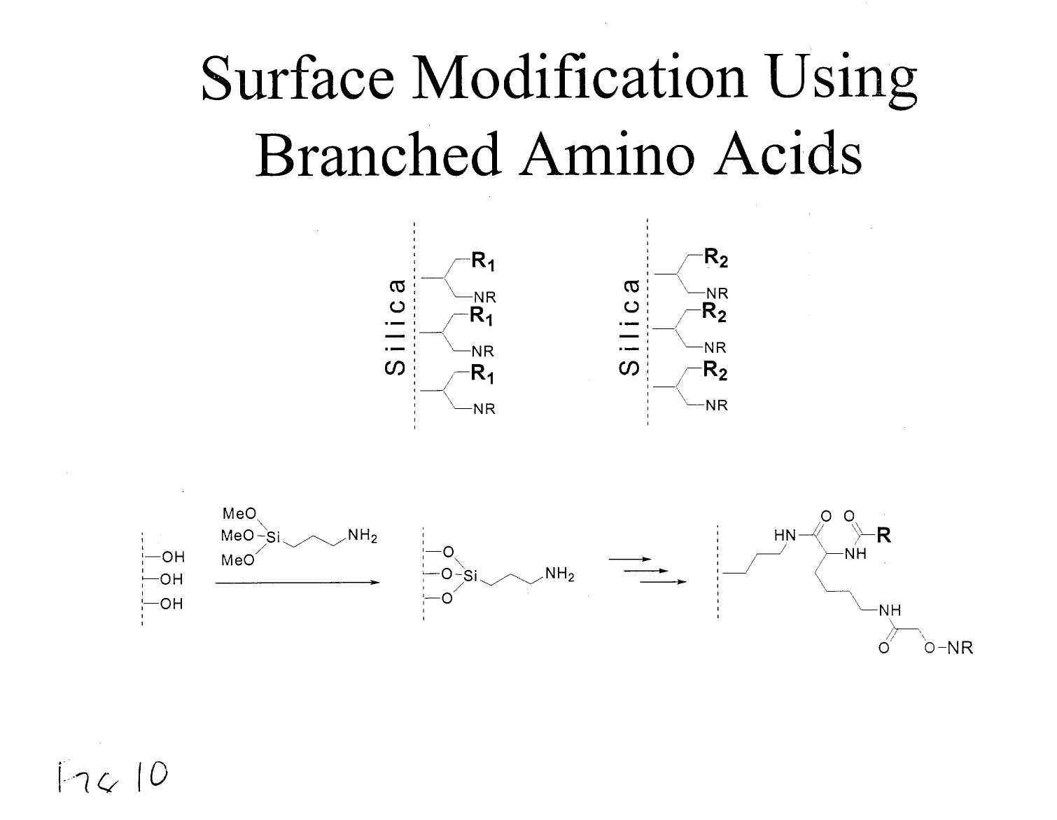

FIG. 11 shows the results of sensors utilizing amino acid linkers. NR is one embodiment, Nile Red. However, as will be appreciated by those in the art, Nile Red can be substituted by any solvatochromic dye.

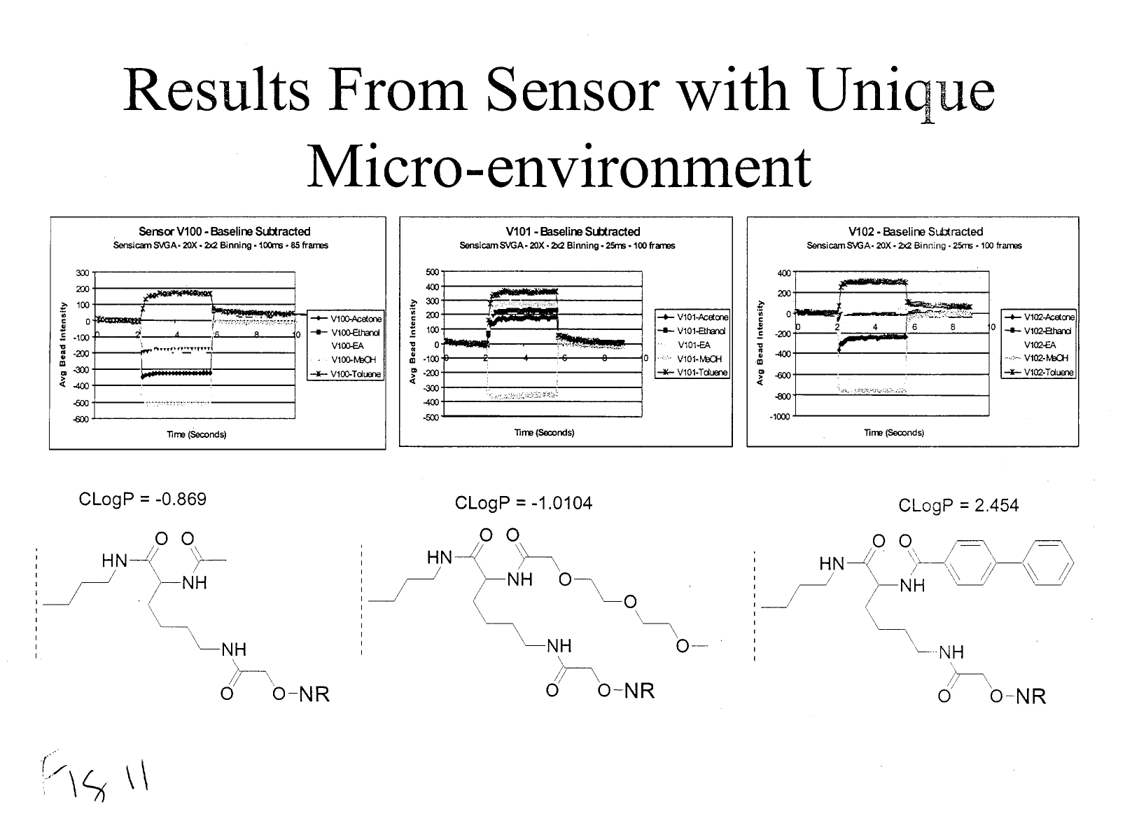

FIG. 12 depicts the use of combinatorial chemistry to result in large amounts of sensor elements.

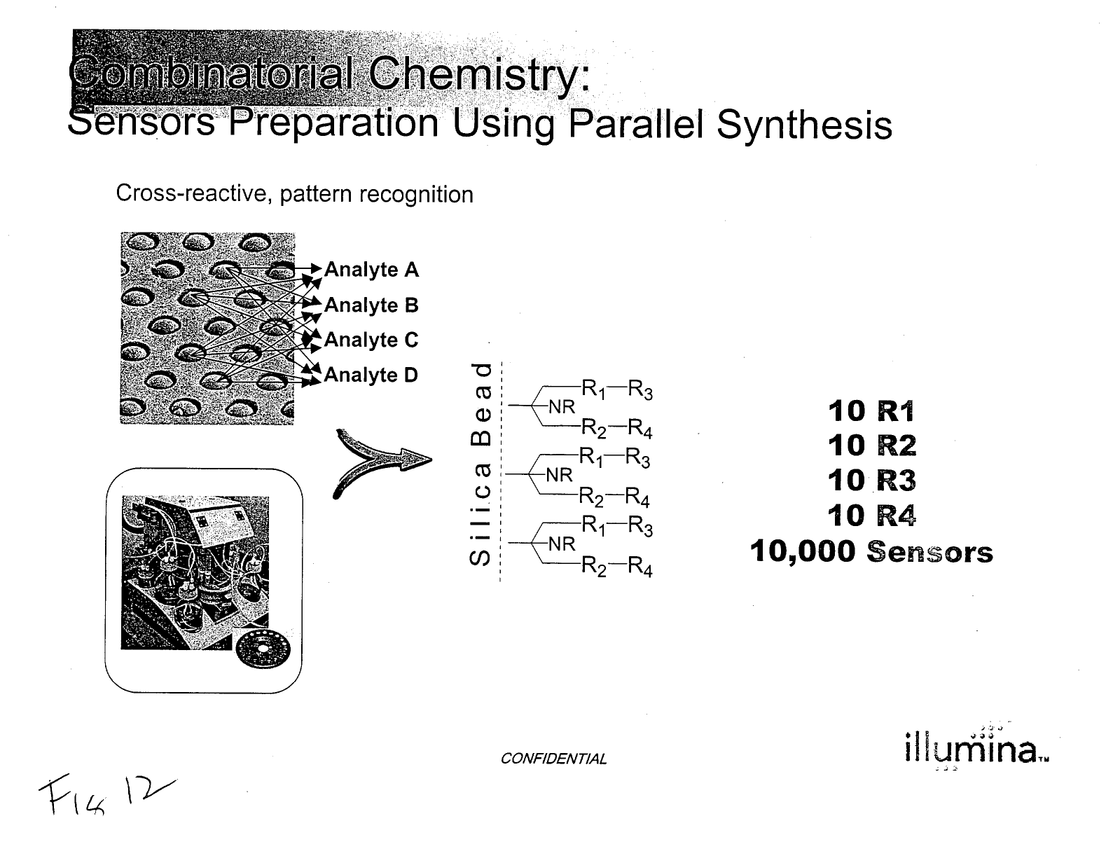

FIG. 13 depicts a schematic of a hand held sensor system.

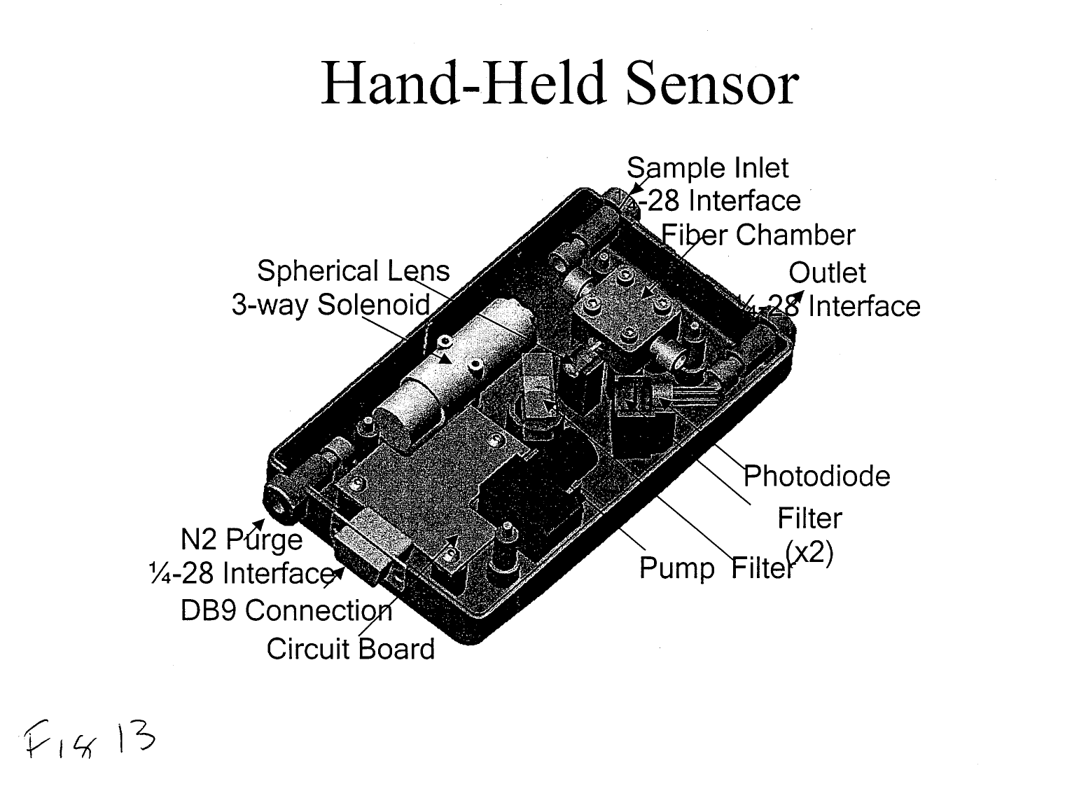

### DETAILED DESCRIPTION OF THE INVENTION

In general, the invention provides sensors that can mimic the mammalian olfactory system which relies on differential responses of a variety of sensor elements to produce a unique “fingerprint” or “signature” comprising the responses of a variety of sensor elements when exposed to either a single target analyte or a mixture of target analytes. That is, some biosensors such as nucleic acid arrays rely on the absolute specificity of a probe on an array to give a “binary” response: either the target is present or absent. However, for analytes that do not have specific or selective binding partners, an alternate approach has been to utilize a plurality of sensor elements that each respond to the target to varying degrees and with varying responses. By comparing the differential responses of the sensor elements, specificity is obtained in the form of a “signature” of sensor responses. While this approach is not unique, the present invention is directed to sensors for the detection of target analytes that rely on the use of micro-environment moieties (MEMs) at sensor element locations to increase the reproducibility, selectivity and specificity of sensors comprising solvatochromic dyes to allow for highly multiplexed and unique sensor arrays. In general, both solvatochromic dye molecules and different MEMs are attached at discrete sites in an array, which increases the range of possible unique sensor elements. While the present invention finds use in a variety of formats, including “spotted” or ordered arrays where a plurality of discrete sites on a surface of a substrate contains a different combination of MEMs and dyes, preferred embodiments utilize sensor elements that are microspheres. Thus, subpopulations of microspheres of the array each contain a different combination of MEMs and dyes, to produce a robust, redundant, selective and specific sensor array. These arrays allow for the characterization, quantification and qualification of complicated fluids.

The present system draws on some aspects of previous work. Arrays are described in U.S. Pat. No. 6,023,540 and U.S. Ser. Nos. 09/151,877, filed Sep. 11, 1998, 09/450,829, filed Nov. 29, 1999, 09/816,651, filed Mar. 23, 2001, and 09/840,012, filed Apr. 20, 2001, all of which are expressly incorporated herein by reference. In addition, other arrays are described in 60/181,631, filed Feb. 10, 2000, 09/782,588, filed Feb. 12, 2001, 60/113,968, filed Dec. 28, 1998, 09/256,943, filed Feb. 24,1999, 09/473,904, filed Dec. 28, 1999, 09/606,369, filed Jun. 28, 2000, and 09/140,352, filed Aug. 26, 1998, all of which are expressly incorporated herein by reference.

Methods for array analysis are described in 08/944,850, filed Oct. 6, 1997, PCT/US98/21193, filed Oct. 6, 1998, 09/287,573, filed Apr. 6, 1999, PCT/US00/09183, filed May 6, 2000, 60/238,866, filed Oct. 6, 2000, 60/119,323, filed Feb. 9, 1999, 09/500,555, filed Feb. 9, 2000, 09/636,387, filed Aug. 9, 2000, 60/151,483, filed Aug. 30, 1999, 60/151,668, filed Aug. 31, 1999, 09/651,181, filed Aug. 30, 2000, 60/272,803, filed Mar. 1, 2001, all of which are expressly incorporated herein by reference.

Accordingly, the present invention provides sensors, particularly sensor arrays, for the detection of target analytes in a fluid. By “sensor array” herein is meant a plurality of sensor elements in an array format; the size of the array will depend on the composition and end use of the array. Arrays containing from about 2 different sensor elements (e.g. different beads comprising different mixtures of dyes and MEMs) to many millions can be made. Generally, the array will comprise from two to as many as a billion or more, depending on the size of the beads and the substrate, as well as the end use of the array, thus very high density, high density, moderate density, low density and very low density arrays may be made. Preferred ranges for very high density arrays are from about 10,000,000 to about 2,000,000,000 (all numbers are per square cm), with from about 100,000,000 to about 1,000,000,000 being preferred. High density arrays range about 100,000 to about 10,000,000, with from about 1,000,000 to about 5,000,000 being particularly preferred. Moderate density arrays range from about 10,000 to about 100,000 being particularly preferred, and from about 20,000 to about 50,000 being especially preferred. Low density arrays are generally less than 10,000, with from about 1,000 to about 5,000 being preferred. Very low density arrays are less than 1,000, with from about 10 to about 1000 being preferred, and from about 100 to about 500 being particularly preferred. In addition, in some arrays, multiple substrates may be used, either of different or identical compositions. Thus for example, large arrays may comprise a plurality of smaller substrates.

The sensor arrays are used to detect target analytes in fluids. By “target analyte” or “analyte” or grammatical equivalents herein is meant any atom, molecule, ion, molecular ion, compound or particle to be detected. As will be appreciated by those in the art, a large number of analytes may be detected in the present invention so long as the subject analyte is capable of generating a differential response across a plurality of sensor elements of the array. Suitable analytes include organic and inorganic molecules. Analyte applications include broad ranges of chemical classes such as organics such as alkanes, alkenes, alkynes, dienes, alicyclic hydrocarbons, arenes, alcohols, ethers, ketones, aldehydes, carbonyls, carbanions, polynuclear aromatics and derivatives of such organics, e.g. halide derivatives, etc., biomolecules such as sugars, isoprenes and isoprenoids, fatty acids and derivatives, etc. Accordingly, commercial applications of the sensors, arrays and noses include environmental toxicology and remediation, biomedicine, materials quality control, food and agricultural products monitoring, etc., including biomolecules. When detection of a target analyte is done, suitable target analytes include, but are not limited to, an environmental pollutant (including pesticides, insecticides, toxins, etc.); a chemical (including solvents, polymers, organic materials, etc.); therapeutic molecules (including therapeutic and abused drugs, antibiotics, etc.); biomolecules (including hormones, lipids, carbohydrates, etc.).

By “fluid” herein is meant either a liquid or a gas. As will be appreciated by those in the art, the stability of the present sensors provide a mimic of the mammalian olfactory system, either in vapor (e.g. sometimes referred to as “an optical nose”) or in liquids (e.g. “an optical tongue”).

The sensor arrays of the present invention comprise a substrate comprising a plurality of discrete sites. By “substrate” or “solid support” or other grammatical equivalents herein is meant any material that can be modified to contain discrete individual sites appropriate for the attachment or association of the dyes and MEMs (and in preferred embodiments, of beads comprising these moieties) and is amenable to at least one detection method suitable for use in the invention. As will be appreciated by those in the art, the number of possible substrates is very large. Possible substrates include, but are not limited to, glass and modified or functionalized glass, plastics (including acrylics, polystyrene and copolymers of styrene and other materials, polypropylene, polyethylene, polybutylene, polyurethanes, Teflon, etc.), polysaccharides, nylon or nitrocellulose, resins, silica or silica-based materials including silicon and modified silicon, carbon, metals, inorganic glasses, plastics, optical fiber bundles, and a variety of other polymers. In general, the substrates allow optical detection and do not themselves appreciably fluoresce.

Generally the substrate is flat (planar), although as will be appreciated by those in the art, other configurations of substrates may be used as well; for example, three dimensional configurations can be used, for example, when beads are used, by embedding the beads in a porous block of plastic that allows sample access to the beads and using a confocal microscope for detection. Similarly, the beads may be placed on the inside surface of a tube, for flow-through sample analysis to minimize sample volume. Preferred substrates include optical fiber bundles as discussed below, and flat planar substrates such as glass, polystyrene and other plastics and acrylics.

In a preferred embodiment, the substrate is an optical fiber bundle or array, as is generally described in U.S. Pat. No. 6,023,540, and U.S. Ser. Nos. 09/151,877 filed Sep. 11, 1998; 09/786,896 filed Sep. 10, 1999; 08/944,850 and 08/519,062, 09/287,573, 09/187,289, 08/519,062, PCT US98/05025, and PCT US98/09163, all of which are expressly incorporated herein by reference.

The substrate has at least one surface, or a plurality of different surfaces, that comprise the discrete sites. At least one surface of the substrate is modified to contain discrete, individual sites for later association of the dyes and MEMs, or, in a preferred embodiment, for association of microspheres comprising these elements. In the case of microspheres, these sites may comprise physically altered sites, i.e. physical configurations such as wells or small depressions in the substrate that can retain the beads, such that a microsphere can rest in the well, or the use of other forces (magnetic or compressive), or chemically altered or active sites, such as chemically functionalized sites, electrostatically altered sites, hydrophobically/hydrophilically functionalized sites, spots of adhesive, etc.

The sites may be a pattern, i.e. a regular design or configuration, or randomly distributed. A preferred embodiment utilizes a regular pattern of sites such that the sites may be addressed in the X-Y coordinate plane. “Pattern” in this sense includes a repeating unit cell, preferably one that allows a high density of beads on the substrate. However, it should be noted that when microspheres are used, one embodiment utilizes a mechanism not requiring discrete sites. That is, it is possible to use a uniform surface of adhesive or chemical functionalities, for example, that allows the association of beads at any position. That is, the surface of the substrate is modified to allow association of the microspheres at individual sites, whether or not those sites are contiguous or non-contiguous with other sites. Thus, the surface of the substrate may be modified such that discrete sites are formed that can only have a single associated bead, or alternatively, the surface of the substrate is modified and beads may go down anywhere, but they end up at discrete sites.

In a preferred embodiment, the surface of the substrate is modified to contain wells, i.e. depressions in the surface of the substrate. This may be done as is generally known in the art using a variety of techniques, including, but not limited to, photolithography, stamping techniques, molding techniques and microetching techniques. As will be appreciated by those in the art, the technique used will depend on the composition and shape of the substrate.

In a preferred embodiment, physical alterations are made in a surface of the substrate to produce the sites. In a preferred embodiment, the substrate is a fiber optic bundle and the surface of the substrate is a terminal end of the fiber bundle, as is generally described in 08/818,199 and 09/151,877, both of which are hereby expressly incorporated by reference. In this embodiment, wells are made in a terminal or distal end of a fiber optic bundle comprising individual fibers. In this embodiment, the cores of the individual fibers are etched, with respect to the cladding, such that small wells or depressions are formed at one end of the fibers. The required depth of the wells will depend on the size of the beads to be added to the wells.

Generally in this embodiment, the microspheres are non-covalently associated in the wells, although the wells may additionally be chemically functionalized as is generally described below, cross-linking agents may be used, or a physical barrier may be used, i.e. a film or membrane over the beads.

In a preferred embodiment, the surface of the substrate is modified to contain chemically modified sites, that can be used to associate, either covalently or non-covalently, the microspheres of the invention to the discrete sites or locations on the substrate. “Chemically modified sites” in this context includes, but is not limited to, the addition of a pattern of chemical functional groups including amino groups, carboxy groups, oxo groups and thiol groups, that can be used to covalently attach microspheres, which generally also contain corresponding reactive functional groups; the addition of a pattern of adhesive that can be used to bind the microspheres (either by prior chemical functionalization for the addition of the adhesive or direct addition of the adhesive); the addition of a pattern of charged groups (similar to the chemical functionalities) for the electrostatic association of the microspheres, i.e. when the microspheres comprise charged groups opposite to the sites; the addition of a pattern of chemical functional groups that renders the sites differentially hydrophobic or hydrophilic, such that the addition of similarly hydrophobic or hydrophilic microspheres under suitable experimental conditions will result in association of the microspheres to the sites on the basis of hydroaffinity. For example, the use of hydrophobic sites with hydrophobic beads, in an aqueous system, drives the association of the beads preferentially onto the sites. As outlined above, “pattern” in this sense includes the use of a uniform treatment of the surface to allow association of the beads at discrete sites, as well as treatment of the surface resulting in discrete sites. As will be appreciated by those in the art, this may be accomplished in a variety of ways.

In a preferred embodiment, the compositions of the invention further comprise a population of microspheres. By “population” herein is meant a plurality of beads as outlined above for arrays. Within the population are separate subpopulations, which can be a single microsphere or multiple identical microspheres. That is, in some embodiments, as is more fully outlined below, the array may contain only a single bead for each unique combination of dye and MEM; preferred embodiments utilize a plurality of beads of each type, e.g. “subpopulations”. This allows for sensor element redundancy and therefore greater reproducibility and sensitivity.

By “microspheres” or “beads” or “particles” or grammatical equivalents herein is meant small discrete particles. The composition of the beads will vary, depending on the class of bioactive agent and the method of synthesis. Suitable bead compositions include those used in peptide, nucleic acid and organic moiety synthesis, including, but not limited to, plastics, ceramics, glass, polystyrene, methylstyrene, acrylic polymers, paramagnetic materials, thoria sol, carbon graphite, titanium dioxide, latex or cross-linked dextrans such as Sepharose, cellulose, nylon, cross-linked micelles and Teflon may all be used. “Microsphere Detection Guide” from Bangs Laboratories, Fishers IN is a helpful guide. Silica is a preferred substrate for the beads.

The beads need not be spherical; irregular particles may be used. In addition, the beads may be porous, thus increasing the surface area of the bead available for moiety attachment. The bead sizes range from nanometers, i.e. 100 nm, to millimeters, i.e. 1 mm, with beads from about 0.2 micron to about 200 microns being preferred, and from about 0.5 to about 5 micron being particularly preferred, although in some embodiments smaller beads may be used.

It should be noted that a key component of the invention is the use of a substrate/bead pairing that allows the association or attachment of the beads at discrete sites on the surface of the substrate, such that the beads do not move during the course of the assay.

In general, each microsphere comprises a dye/MEM pairing, although as will be appreciated by those in the art, there may be some microspheres which do not contain any moieties, depending on the synthetic methods.

Each discrete site, e.g. each microsphere in a well on the surface of the substrate, comprises a solvatochromic dye. Solvatochromic dyes are dyes having spectroscopic characteristics (e.g., absorption, emission, fluorescence, phosphorescence) in the ultraviolet/visible/near-infrared spectrum that are influenced by the surrounding medium, and in the present invention, particularly by the presence of a MEM. Both the wavelength-dependence and the intensity of a dye's spectroscopic characteristics are typically affected. **RR

The solvatochromic dye suitable for use with the invention may be any known solvatochromic dye. Solvatochromic dyes have been extensively reviewed in, for example, C. Reichardt, Chemical Reviews, volume 94, pages 2319-2358 (1994); C. Reichardt, S. Asharin-Fard, A. Blum, M. Eschner, A.-M. Mehranpour, P. Milart, T. Nein, G. Schaefer, and M. Wilk, Pure and Applied Chemistry, volume 65, no. 12, pages 2593-601 (1993); E. Buncel and S. Rajagopal, Accounts of Chemical Research, volume 23, no. 7, pages 226-31 (1990), all of which are expressly incorporated herein be reference.

Other characteristics of the dyes include positive or negative solvatochromic which corresponds to the bathochromic and hypsochromic shifts, respectively of the emission band with increasing solvent polarity. In addition to the solvent-induced spectral shifts of the emission spectra, some dyes exhibit the solvent-dependent ratio of emission intensities of two fluorescence bands. One such solvatochromic dye is pyrene (1-pyrenebutanoic acid).

Solvatochromic dyes include, but are not limited to 4-dicyanmethylene-2-methyl-6-(p-dimethylaminostyryl)-4H-pyran (DCM; CAS Registry No. 51325-91-8); 6-propionyl-2-(dimethylamino)naphthalene (PRODAN; CAS Registry No. 70504-01-7); 9-(diethylamino)-5H-benzo[a]phenoxazin-5-one (Nile Red; CAS Registry No. 7385-67-3); 4-(dicyanovinyl)julolidine (DCVJ); phenol blue; stilbazolium dyes; coumarin dyes; ketocyanine dyes, including CAS Registry No. 63285-01-8; Reichardt's dyes including Reichardt's Betaine dye (2,6-diphenyl-4-(2,4,6-triphenylpyridinio) phenolate; CAS Registry No. 10081-39-7); merocyanine dyes, including merocyanine 540 (CAS Registry No. 62796-23-0); N,N-dimethyl-4-nitroaniline (NDMNA; CAS Registry No. 100-23-2) and N-methyl-2-nitroaniline (NM2NA; CAS Registry No. 612-28-2); and the like. Other solvatochromic dyes include, but are not limited to Nile blue; 1-anilinonaphthalene-8-sulfonic acid (1,8-ANS), and dapoxylbutylsulfonamide (DBS) as well as other dapoxyl analogs. In a preferred embodiment the solvatochromic dye is Nile Red.

In a preferred embodiment, the solvatochromic dye is covalently attached to the site. By “covalently attached” herein is meant that two moieties are attached by at least one bond, including sigma bonds, pi bonds and coordination bonds. As is further outlined below, preferred embodiments utilize beads with covalently attached dyes and MEMs, that are associated on the discrete sites, e.g. wells, of the sensor array. Similarly outlined further below, the covalent attachment may be done using a linker, which has covalently attached moieties and is itself covalently attached to the bead.

Alternatively, there are a variety of entrapment systems that are used to entrap or contain dyes and other materials within a microsphere. In these embodiments, either the dye or the MEM is entrapped, with the other moiety being covalently attached; that is, preferred embodiments utilize at least one (and preferably both) moiety being covalently attached.

As is more further outlined below, both the dyes and the MEMs can be functionalized in a variety of ways to provide a functional moiety for attachment to the surface or bead.

In addition, each discrete site (e.g. preferably microsphere) comprises at least one micro-environment moiety (MEM). As above for dyes, the MEM is preferably covalently attached, although some systems allow for “entrapment” within a bead. MEMs alter the micro-environment that the dye “sees” in a variety of ways, by varying any number of physical, steric or chemical properties; generally any intramolecular force can be the focus of the MEM. For example, MEMs may alter polarity, hydrophobicity, hydrophilicity, electrostatic interactions, Van der Waals forces, hydrogen bonding, steric forces, etc. can all be utilized. Preferred MEMs effect the hydrophobicity and/or the hydrophilicity of the environment of the dye. Particularly preferred are MEMs that alter polarity.

Suitable MEMs include, but are not limited to, alkyl (including substituted alkyl, heteroalkyl, substituted heteroalkyl) and aryl (including substituted aryl, heteroaryl, substituted heteroaryl).

By “alkyl group” or grammatical equivalents herein is meant a straight or branched chain alkyl group, with straight chain alkyl groups being preferred. If branched, it may be branched at one or more positions, and unless specified, at any position. The alkyl group may range from about 1 to about 30 carbon atoms (C1-C30), with a preferred embodiment utilizing from about 1 to about 20 carbon atoms (C1-C20), with about C1 through about C12 to about C15 being preferred, and C1 to C5 or C6 being particularly preferred, although in some embodiments the alkyl group may be much larger. Also included within the definition of an alkyl group are cycloalkyl groups such as C5 and C6 rings, and heterocyclic rings with nitrogen, oxygen, sulfur or phosphorus. Alkyl also includes heteroalkyl, with heteroatoms of sulfur, oxygen, nitrogen, and silicone being preferred. Typical heteroatoms and/or heteroatomic groups which can replace the carbon atoms include, but are not limited to, —O—, —S—, —S—O—, —NR′—, —PH—, —S(O)—, —S(O)2-, —S(O) NR′—, —S(O)2NR′—, and the like, including combinations thereof, where each R′ is independently selected and defined below. Alkyl includes substituted alkyl groups. By “substituted alkyl group” herein is meant an alkyl group further comprising one or more substitution moieties “R”, as defined below. Alkyl includes alkenyl and alkynyl as well. “Alkenyl” by itself or as part of another substituent refers to an unsaturated branched, straight-chain or cyclic alkyl having at least one carbon-carbon double bond derived by the removal of one hydrogen atom from a single carbon atom of a parent alkene. The group may be in either the cis or trans conformation about the double bond(s). “Alkynyl” by itself or as part of another substituent refers to an unsaturated branched, straight-chain or cyclic alkyl having at least one carbon-carbon triple bond derived by the removal of one hydrogen atom from a single carbon atom of a parent alkyne.

“Aryl” by itself or as part of another substituent refers to a monovalent aromatic hydrocarbon group having the stated number of carbon atoms (i.e., C5-C15 means from 5 to 15 carbon atoms) derived by the removal of one hydrogen atom from a single carbon atom of a parent aromatic ring system. Typical aryl groups include, but are not limited to, groups derived from aceanthrylene, acenaphthylene, acephenanthrylene, anthracene, azulene, benzene, chrysene, coronene, fluoranthene, fluorene, hexacene, hexaphene, hexalene, asindacene, sindacene, indane, indene, naphthalene, octacene, octaphene, octalene, ovalene, penta 2,4 diene, pentacene, pentalene, pentaphene, perylene, phenalene, phenanthrene, picene, pleiadene, pyrene, pyranthrene, rubicene, triphenylene, trinaphthalene, and the like, as well as the various hydro isomers thereof. In preferred embodiments, the aryl group is (C5 C15) aryl, with (C5 C10) being even more preferred. Particularly preferred aryls are phenyl and substituted phenyl.

Suitable R substitutent groups include, but are not limited to, hydrogen, alkyl (and all its derivatives outlined herein), aryl (and all its derivatives outlined herein), alcohol (including ethylene glycols), alkoxy, amino, amido, nitro, ethers, esters, aldehydes, sulfonyl, silicon moieties, halogens, sulfur containing moieties, phosphorus containing moieties. In the structures depicted herein, R is hydrogen when valency so requires and the position is otherwise unsubstituted. It should be noted that some positions may allow two substitution groups, R and R′, in which case the R and R′ groups may be either the same or different. In general, preferred structures that require both R and R′ have one of these groups as a hydrogen. In addition, R groups on adjacent carbons, or adjacent R groups, can be attached to form cycloalkyl or cycloaryl groups, including heterocycloalkyl and heterocycloaryl groups (and substituted derivatives thereof) together with the carbon atoms of the ring. These may be multi-ring structures as well.

By “alkoxyl” herein is meant —OR, with R being a group as defined herein. Particularly preferred are —OC1-C3, with methyoxy and ethoxyl being particularly preferred.

By “amino groups” or grammatical equivalents herein is meant —NH2, —NHR and —NR2 groups, with R being as defined herein.

By “nitro group” herein is meant an —NO2 group.

By “sulfur containing moieties” herein is meant compounds containing sulfur atoms, including but not limited to, thia-, thio- and sulfo-compounds, thiols (—SH and —SR), and sulfides (—RSR—). By “phosphorus containing moieties” herein is meant compounds containing phosphorus, including, but not limited to, phosphines and phosphates. By “silicon containing moieties” herein is meant compounds containing silicon.

By “ether” herein is meant an —O—R group. Preferred ethers include alkoxy groups, with —O—(CH2)2CH3 and —O—(CH2)4CH3 being preferred.

By “ester” herein is meant a —COOR group.

By “halogen” herein is meant bromine, iodine, chlorine, or fluorine. Preferred substituted alkyls are partially or fully halogenated alkyls such as CF3, etc.

By “aldehyde” herein is meant —RCOH groups.

By “alcohol” herein is meant —OH groups, and alkyl alcohols —ROH.

By “amido” herein is meant —RCONH— or RCONR— groups.

As will be appreciated by those in the art, the range of possible MEMs is quite high. Functionally, a MEM will alter the response of a solvatochromic dye to at least one analyte when present on the sensor element, and this is easily assayed. Particularly preferred MEMs are depicted in the figures and include moieties generally comprising short alkyl groups and either electron donating or withdrawing groups, or charged moieties.

The MEMs and dyes are covalently attached to the sites, e.g. the microspheres, in a variety of ways. In a preferred embodiment, these moieties are directly attached to the sites. In a preferred embodiment, the moieties are synthesized first (or purchased), and then covalently attached to the beads (or site, as the case may be). As will be appreciated by those in the art, this will be done depending on the composition of the moieties and the beads. The functionalization of solid support surfaces such as certain polymers with chemically reactive groups such as silanes, thiols, amines, carboxyls, etc. is generally known in the art. Accordingly, “blank” microspheres (or “blank” surfaces) may be used that have surface chemistries that facilitate the attachment of the desired functionality by the user (for example by spotting or printing in the case of non-bead systems). Some examples of these surface chemistries for blank microspheres include, but are not limited to, amino groups including silanes, hydroxy groups for silane attachment, aliphatic and aromatic amines, carboxylic acids, aldehydes, amides, chloromethyl groups, hydrazide, hydroxyl groups, sulfonates and sulfates.

These functional groups can be used to add any number of different moieties to the beads or surface, generally using known chemistries. For example, linkers as outlined below comprising carbohydrates (e.g. polydextrans, etc.) may be attached to an amino-functionalized support; the aldehyde of the carbohydrate is made using standard techniques, and then the aldehyde is reacted with an amino group on the surface. In an alternative embodiment, a sulfhydryl linker may be used. There are a number of sulfhydryl reactive linkers known in the art such as SPDP, maleimides, α-haloacetyls, and pyridyl disulfides (see for example the 1994 Pierce Chemical Company catalog, technical section on cross-linkers, pages 155-200, incorporated herein by reference) which can be used to attach cysteine containing moieties (e.g. amino acid oligomers) to the support. Alternatively, an amino group on the dye or MEM moiety may be used for attachment to an amino group on the surface. For example, a large number of stable bifunctional groups are well known in the art, including homobifunctional and heterobifunctional linkers (see Pierce Catalog and Handbook, pages 155-200). In an additional embodiment, carboxyl groups (either from the surface or from the candidate agent) may be derivatized using well known linkers (see the Pierce catalog). For example, carbodiimides activate carboxyl groups for attack by good nucleophiles such as amines (see Torchilin et al., Critical Rev. Therapeutic Drug Carrier Systems, 7(4):275-308 (1991), expressly incorporated herein). Preferred methods of attachment are shown in the figures, and utilize silane chemistry for the covalent attachment of dyes and MEMs.

It should be understood that the moieties may be attached in a variety of ways, including those listed above. Preferably, the manner of attachment does not significantly alter the functionality of the moiety; that is, the dye should remain solvatochromic and the MEM should remain capable of altering the environment and thus the dye response.

When the dyes and MEMs are separately attached, a variety of configurations are possible. In some embodiments, sensor repertoire is increased by altering the ratio of dye:MEM at a particular location; that is, a 1:1 ratio may be used to give one response, 10:1 another, 1:10 yet another, etc. Alternatively, sensor repertoire is increased by using a plurality of MEMs with a single dye at a particular location, or using a matrix of different dyes and different MEMs. As outlined below, these same strategies will work with oligomeric linkers as well.

As will be appreciated by those in the art, the chemistry of attachment will depend on the composition of the surface of attachment. In a preferred embodiment, the surface comprises silica and silane chemistry is used to functionalize the surface and attach the moieties.

In the case where a single attachment site is used to attach a plurality of moieties (e.g. either one or more dyes, one or MEMs, or combinations of dye(s) and MEM(s)), attachment linkers may be used.

In general, there are two types of linkers used. In the first embodiment, the linker is an attachment linker that is used to attach a single dye (or a single MEM) to the site.

Alternatively, oligomeric linkers are used to attach multiple moieties to the site, either multiple dyes, multiple MEMs, or mixtures. As outlined in the Figures, there are a wide variety of possible configurations and linkers in this embodiment, and a corresponding wide variety of possible oligomeric linkers. As used herein, an “oligomer” comprises at least two or three subunits, which are covalently attached. Oligomer in this sense includes different subunits as well as identical subunits (sometimes referred to as a “polymer” when the subunits are identical). At least some portion of the monomeric subunits contain functional groups for the covalent attachment of moieties including MEMs and dyes. In some embodiments coupling moieties are used to covalently link the subunits with the moieties. Preferred functional groups for attachment are amino groups, carboxy groups, oxo groups and thiol groups, with amino groups and ether groups being particularly preferred. As will be appreciated by those in the art, a wide variety of polymers are possible. Suitable polymers include functionalized styrenes, such as amino styrene, functionalized dextrans, and polyamino acids. Preferred polymers are polyamino acids (both poly-D-amino acids and poly-L-amino acids), such as polylysine, and polymers containing lysine and other amino acids being particularly preferred. Other suitable polyamino acids are polyglutamic acid, polyaspartic acid, co-polymers of lysine and glutamic or aspartic acid, co-polymers of lysine with alanine, tyrosine, phenylalanine, serine, tryptophan, and/or proline. These polyamino acids are preferred due to their available side chains which can be used as functional groups for attachment of the moieties. In some cases, a single amino acid can be used, with either the N- or C-terminus as well as the side chain functionality being used for attachment of the moieties.

In a preferred embodiment, the polymer contains a single type of functional moiety for covalent attachment. In this embodiment, both moieties are attached using the same functionality. In this embodiment, as is outlined herein, one or some portion of the subunits contain MEMs, some portion contains dyes, and generally some portion of the subunits do not contain either, as is more fully described below. As will be described herein, in some instances the unreacted functional groups are protected or “capped” to neutralize the functionality, if desired.

In this embodiment, every monomeric subunit may contain the same functional moiety, or alternatively some of the subunits comprise a functional moiety and others do not. Thus, for example, polylysine is an example of a polymer in which every subunit comprises an amino functional group. Polyamino acids comprising lysine and alanine are an example of polymers in which some of the subunits do not comprise a chemically reactive functional moiety, as the alanine amino acids do not contain a functional moiety that can be used to covalently attach either moiety, and thus do not need to be protected.

In a preferred embodiment, the polymer comprises different, i.e. at least two, functional groups. Thus for example, polystyrene with amino and thiol functional groups can be made or polyamino acids with two functional groups, such as polymers comprising lysine (ε-amino functional group) and glutamic acid (carboxy functional group). In this embodiment, one functionality is used to add the MEM moiety and the other is used to add the dye. Polymers can be generated that contain more than two functionalities as well.

In this embodiment, as described above, it is also possible to incorporate monomeric subunits that do not contain a functional moiety.

The length of the oligomer can vary widely depending on the components of the sensor elements.

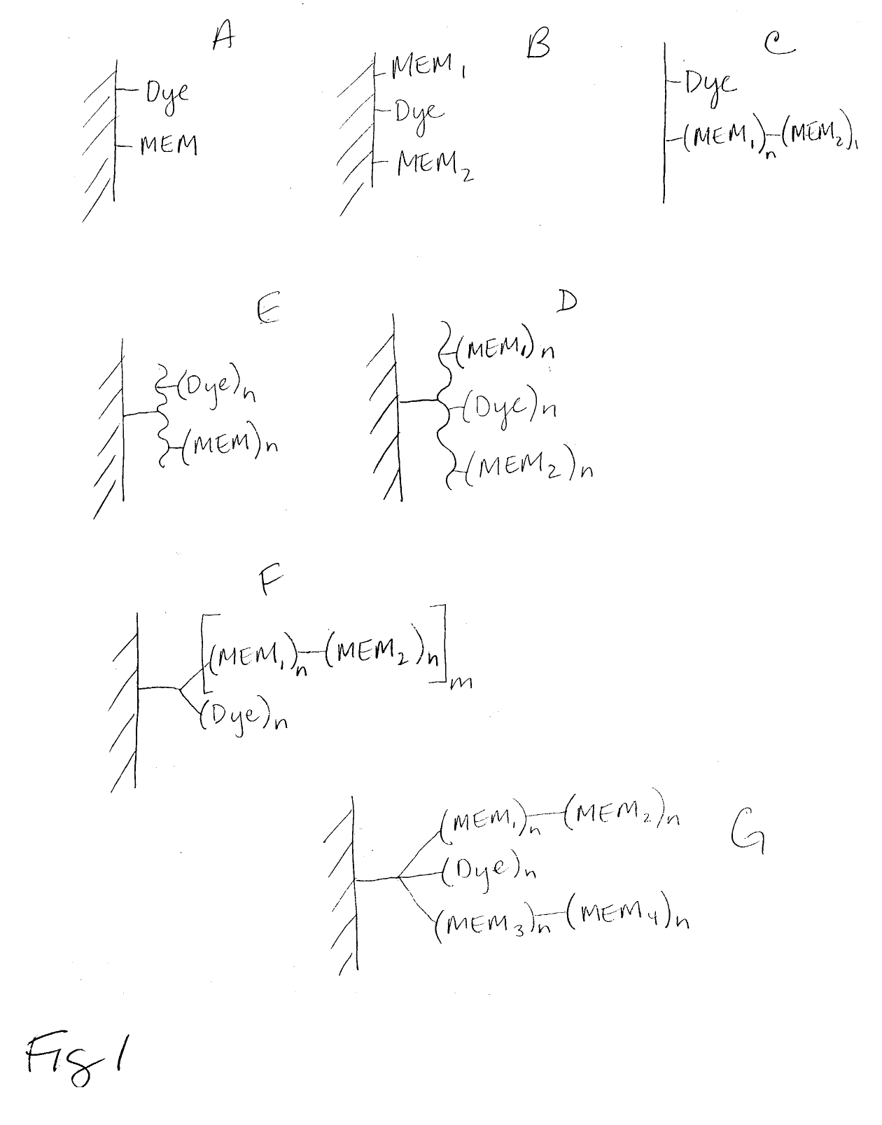

The smallest oligomer has two or three monomeric subunits, (n=2 or n=3) one of which has a MEM covalently attached, and another of which has a dye covalently attached, although other ratios are allowed, as outlined below, and in some cases a single monomeric unit is used. In some embodiments, a third monomeric subunit is between them, to minimize unnecessary steric interactions, although this is not required. In one embodiment, a monomeric unit is used to attach a single moiety to the surface, for example as depicted in FIGS. 1A and 1B.

A preferred embodiment utilizes a linker that attaches a single dye molecule and a single MEM molecule as depicted in FIGS. 1A, 1B and 1E. An alternate preferred embodiment utilizes a linker that attaches multiple MEMs as depicted in FIG. 1C. A further preferred embodiment utilizes a linker that attaches multiple MEMs with either a single dye molecule or multiple dyes (FIGS. 1D-1G).

The MEMs and dyes are attached to the surface as outlined above for attachment to either beads or sites on the substrate. In a preferred embodiment, complicated MEMs systems are made through the use of standard combinatorial chemistry as depicted in the Figures.

In some cases, when beads are not used, the solutions containing the MEMs and dyes can be spotted (including printed) onto the substrate to form the array, using standard and well known techniques, such as those used to make nucleic acid arrays. In these embodiments, the MEM and dye can be premixed, or spotted separately. In some cases, one of the components of the system is synthesized directly on the surface (this can hold true for beads as well). For example, supports on which oligomers are made with different functionalities with subsequent attachment of dyes and/or MEMs. Similarly, the MEM may be synthesized on the surface and dyes added subsequently.

In a preferred embodiment, beads are used, and again, the components of the system can be either synthesized on the beads or added after synthesis, or a combination. In bead arrays, when non-covalent methods are used to associate the beads to the array, the beads are “loaded” in a variety of ways. In general, the loading comprises exposing the array to a solution of microspheres (generally just dipping the array into the bead solution and/or spotting bead solution onto the surface) and removing excess beads. Optionally, energy is then applied, e.g. agitating or vibrating the mixture. In some cases, this results in an array comprising more tightly associated particles, as the agitation is done with sufficient energy to cause weakly-associated beads to fall off (or out, in the case of wells). These sites are then available to bind a different bead. In this way, beads that exhibit a high affinity for the sites are selected. Preferably, the entire surface to be “loaded” with beads is in fluid contact with the solution. This solution is generally a slurry ranging from about 10,000:1 beads:solution (vol:vol) to 1:1. Generally, the solution can comprise any number of reagents, including aqueous buffers, organic solvents, salts, other reagent components, etc. In addition, the solution preferably comprises an excess of beads; that is, there are more beads than sites on the array. Preferred embodiments utilize two-fold to billion-fold excess of beads.

Once made, the sensors of the invention find use in a variety of applications, including but not limited to the monitoring of air and liquid samples, including for example environmental samples, testing for water and air purity, sensing for specific analytes or their lack thereof in the food industry (e.g. sampling wine and beer aging, both gaseous and liquid samples, presence of vapors associated with spoilage or contamination), monitoring other odorants, chemical waste streams, pollutants, pesticides, herbicides, chemical spills, etc.

Upon exposure to an analyte, the different sensor elements have different optical responses which are recorded. The response are generated by measuring intensity changes, spectral shift, and time-dependent variations associated with the sensor elements upon exposure to either reference fluids (methanol, ethanol, DMF, DCM, acetone, acetic acid, toluene, etc.). Analysis of the intensity variations at a particular bandwidth during an image sequence generates a unique temporal response pattern for each sensor based on changes in (for example) polarity of the micro-environment of the sensor element. Pattern recognition software is then used to correlate the response pattern with the target analyte(s) being detected.

The sensor system may include a variety of additional components including devices for monitoring temporal responses of each sensor element, assembling and analyzing sensor data to determine analyte identity, etc. In operation, each sensor element provides a first optical response when contacted with a first fluid and a second optical response when contacted with either a second fluid or the first fluid at a different concentration. That is, the first and second fluids may reflect samples from two different environments, a change in the concentration of an analyte in a fluid sampled at two time points, a sample and a negative control, etc. The sensor array necessarily comprises sensors which respond differently to a change in an analyte concentration.

In a preferred embodiment, a white light source is used as the excitation source. In a preferred embodiment, the light is filtered by a dichroic filter and an excitation filter before reaching the sensor. The resulting fluorescence (or other optical response) of the individual sensor elements (e.g. beads) is transmitted to a CCD camera, although other detection systems can be used as well. In the case where fiber optic bundles are used, the resulting fluorescence is transmitted back through the fiber and the filters to a CCD camera wherein an image is captures. A series of these images are taken during an experiment allowing the fluorescent or optical intensity of the sensor elements to be monitored while detecting the sample fluid. A typical analysis includes a nitrogen baseline, vapor or other fluid response and sensor element recovery and occurs in less than 10 seconds. Taking advantage of the rapid response times allows very rapid analyses, depending on the number of sensor elements.

In a preferred embodiment, the temporal response of each sensor (optical response as a function of time) is recorded. The temporal response of each sensor may be normalized to a maximum percent increase and percent decrease in response which produces a response pattern associated with the exposure of the analyte. By iterative profiling of known analytes, a structure-function database correlating analytes and response profiles is generated. Unknown analytes may then be characterized or identified using response pattern comparison and recognition algorithms. Similarly, the sensor response for mixtures of analytes may be decoded or deconvoluted using these databases as well as iterative sampling. Accordingly, analyte detection systems comprising sensor arrays, an optical measuring devise for detecting the response of each sensor element, a computer, a data structure of sensor array response profiles, and a comparison algorithm are provided. In addition, when bead sensors are used, the availability of high redundancy (e.g. subpopulations of sensor element beads) allows for bead summing as outlined in the applications incorporated above, as well as sophisticated signal detection and processing algorithms having to do with bead detection, etc. See U.S. Ser. Nos. 09/925,941, 60/357,213 and WO 00/60332, hereby incorporated by reference in their entirety.

In a preferred embodiment, the entire sensor system is contained within a handheld unit as shown in the Figures.

All references cited herein are incorporated by reference.

We claim:

1. A sensor array for the detection of target analytes comprising a substrate comprising a surface comprising discrete sites, each discrete site comprising:
a) a covalently attached solvatochromic dye; and
b) at least one different covalently attached micro-environment moiety (MEM).

2. A sensor array according to claim 1 wherein each discrete site comprises a microsphere.

3. A sensor array according to claim 2 wherein said microspheres are distributed in wells on a surface of said substrate.

4. A sensor array according to claim 1 wherein said solvatochromic dye is Nile Red.

5. A sensor array according to claim 1 wherein said dye and said MEM are attached at different locations at said site.

6. A sensor array according to claim 1 further comprising a linker covalently attached to each of said sites, wherein said linker comprises said dye and said MEM.

7. A sensor array according to claim 6 wherein said linker is an oligomer.

8. A sensor array according to claim 7 wherein said oligomer is an amino acid.

9. A sensor array according to claim 1 wherein at least one site comprises a plurality of MEMs.

10. A sensor array according to claim 1 wherein at least one site comprises a plurality of solvatochromic dyes.

11. A sensor array according to claim 10 wherein at least two sites comprise a plurality of MEMs, and said two sites comprises a different plurality.

12. A sensor array for the detection of target analytes comprising a substrate comprising:
a) a population of microspheres comprising a first and a second subpopulation, each member of each subpopulation comprising:
i) a covalently attached solvatochromic dye; and
ii) at least one covalently attached micro-environment moiety (MEM); wherein the MEM on each subpopulation is different;
wherein said microspheres are distributed at discrete sites on a surface of said substrate.

13. A method of detecting a target analyte in a sample comprising:
a) contacting said sample to a sensor array comprising:
i) a substrate comprising a surface comprising discrete sites, each discrete site comprising:
1) a covalently attached solvatochromic dye; and
2) at least one different covalently attached micro-environment moiety (MEM); and
b) measuring the optical response of a plurality of discrete sites.

14. A method according to claim 13 further comprising comparing said response to the response of a reference sample.
